(19) United States
(12) Patent Application Publication
(10) Pub. No.: US 2017/0033560 A1
(43) Pub. Date: Feb. 2, 2017

(54) METHOD AND APPARATUS FOR CONTROLLING A LOAD SHEDDING DEVICE

(71) Applicant: Enphase Energy, Inc., Petaluma, CA (US)

(72) Inventor: John Scott Berdner, Grass Valley, CA (US)

(21) Appl. No.: 15/225,116

(22) Filed: Aug. 1, 2016

Related U.S. Application Data
(60) Provisional application No. 62/199,673, filed on Jul. 31, 2015.

(51) Int. Cl. H02J 3/00; H02J 3/38; H02J 3/14

(52) U.S. Cl. CPC H02J 3/005; H02J 3/14; H02J 3/383

(57) ABSTRACT

The present invention is directed to a method and apparatus for load shedding while maintaining distributed energy resource (DER) support of a power grid. In one embodiment, the method comprises monitoring, by a load shedding device that electrically couples a power grid to each of a distributed energy resource (DER) and at least one load, a frequency of the power grid; determining whether the frequency is less than a load disconnect frequency threshold; and disconnecting, by the load shedding device when the frequency is less than the load disconnect frequency threshold, the at least one load from the power grid while maintaining the electrical connection between the DER and the power grid.

### CROSS-REFERENCE TO RELATED APPLICATIONS

This application claims benefit of U.S. provisional patent application Ser. No. 62/199,673, entitled “Load Shedding Device for Retrofit Applications” and filed Jul. 31, 2015, which is herein incorporated in its entirety by reference.

### BACKGROUND OF THE INVENTION

Field of the Invention

Embodiments of the present disclosure relate generally to load shedding and, in particular, to controlling load shedding on feeder segments containing distributed energy resources.

Description of the Related Art

Utilities generally rely on load shedding schemes to maintain frequency stability on the grid during loss of generation events. Frequency load shedding is the primary tool used to maintain frequency stability on the grid during under-frequency events. Traditionally, these load shedding schemes disconnect entire feeders or feeder segments such that grid loading is reduced and grid frequency returns to a nominal value, e.g., 60 Hz in the United States. As levels of distributed energy resources (DER) such as alternative energy resources increase, the amount of net load on a feeder decreases and the effectiveness of feeder or feeder segment load shedding decreases. In some cases, for example, where a feeder contains many residences generating power, feeder-based load shedding of that feeder can actually result in a net loss of power generation. In addition, the energy output of DER systems varies throughout the day making it much harder to predict the effectiveness of load shedding of a particular feeder or feeder segment.

Therefore, there is a need in the art for a method and apparatus for controlling load shedding to increase the effectiveness of load shedding schemes in systems with distributed energy resources.

### SUMMARY OF THE INVENTION

Embodiments of the present invention generally relate to a method and apparatus for load shedding while maintaining distributed energy resource (DER) support of a power grid as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a power distribution system comprising a load shedding device according to one embodiment;

FIG. 2 depicts a block diagram of a load shedding device in a residential home in accordance with exemplary embodiments of the present invention;

FIG. 3 illustrates a timing diagram for controlling a load shedding controller according to grid frequency in accordance with exemplary embodiments of the present invention; and

FIG. 4 depicts a flow diagram for a method for load shedding while maintaining DER support for a power grid distribution system in accordance with exemplary embodiments of the present invention.

### DETAILED DESCRIPTION

Embodiments of the present invention generally relate to a method and apparatus for controlling a load-shedding device. In one embodiment, the method comprises receiving load-shedding parameters at a load shedding device located at a residential home or other site where power grid loading occurs. The load shedding device monitors the frequency of the grid for any undesirable change. If an undesirable frequency shift is detected (in some instances, for a predetermined period of time), the load shedding device sheds the local load, while preserving generation from the site's power generator (collectively, distributed energy resources, or DERs). Accordingly, load shedding becomes much more granular than disconnecting an entire feeder or feeder segment and net generation loss is avoided during load shedding conditions by keeping DERs online.

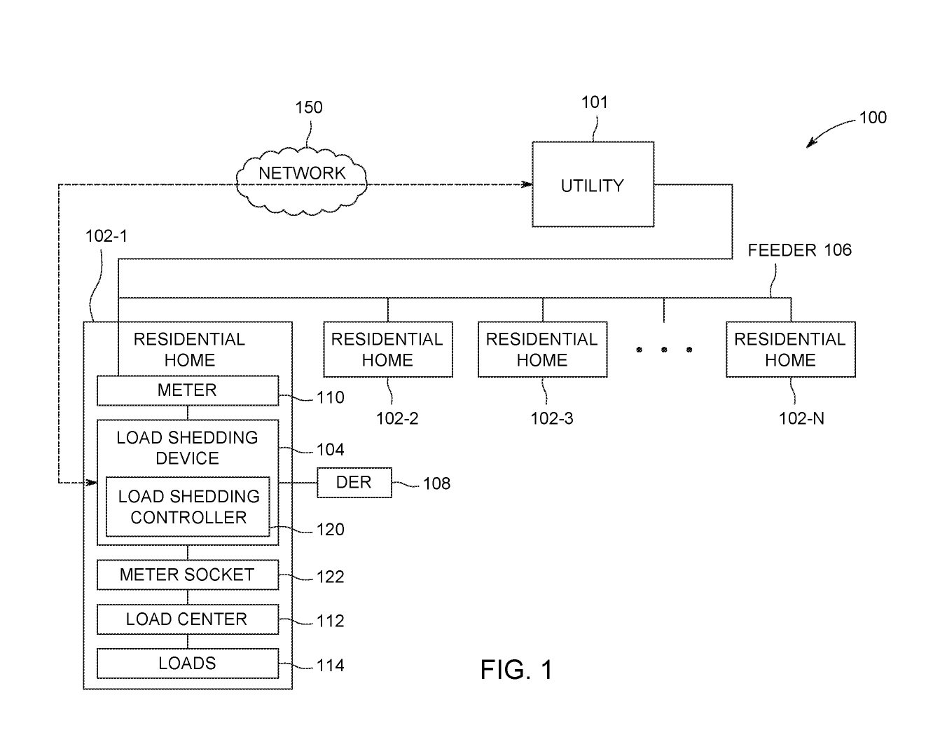

FIG. 1 depicts a block diagram of a power distribution system 100 comprising a load shedding device 104 according to one embodiment of the present invention.

The power distribution system 100 (which may also be referred to as the system 100) comprises a plurality of residential homes 102-1, 102-2, 102-3 . . . 102-N, collectively referred to as homes 102. The homes 102 are coupled to a utility 101 via a feeder line 106. The homes 102 receive power from the utility 101 via the feeder line 106 for powering one or more associated loads, such as the loads 114 depicted with respect to the home 102-1. Additionally, the home 102-1 provides energy resources to the utility 101 via locally installed distributed energy resource (DER) 108. The DER 108 provides alternative power generation and energy storage systems such as solar power systems, gas turbines, wind turbines, hydro-electric generators, fuel cells, AC batteries, and the like.

The home 102-1 comprises a load shedding device 104 coupled between a utility power meter 110 (which is further coupled to the feeder line 106) and a power meter interface 122 (which may be referred to as a meter socket 122). The power meter socket 122 is coupled to a load center 112, which is further coupled to the loads 114 for distributing power to the loads 114. The DER 108 is coupled to the load shedding device 104.

In some embodiments, one or more of the homes 102-2-102-N has a corresponding DER analogous to the DER 108. Each of the residential homes 102-2-102-N having a corresponding DER is equipped with a load shedding device (analogous to the load shedding device 104) that couples the corresponding local loads and DER to the feeder line 106 as described herein with respect to the home 102-1.

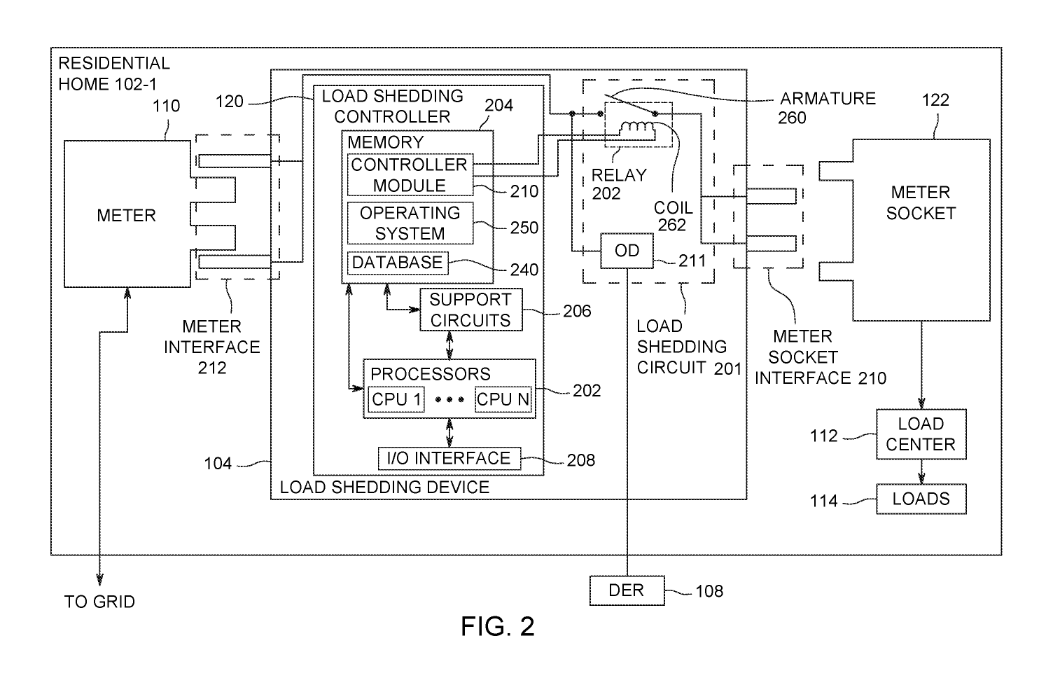

The load shedding device 104 provides localized load shedding capability at the site level while keeping local generation resources (i.e., the DER 108) online. According to this embodiment, the load shedding device 104 is an autonomous device placed between the home's power meter 110 and the power meter socket 122, as described in more detail below with respect to FIG. 2, although in other embodiments the load shedding device 104 may be located in a different position. For example, in other embodiments, the load shedding device 104 may be built into the power meter 110 or into the residential load center 112. In still other embodiments, the load shedding device 104 may take a granular form, for example as a pluggable device forming an interface between one or more appliances/devices and an electrical outlet. In some other embodiments, the load shedding device 104 may be embedded in electrical outlets or a site's wiring system. In yet another embodiment, the load shedding device 104 may be embedded/integrated within an appliance or device.

The load shedding device 104 acts autonomously to control load shedding by comparing local grid conditions (i.e., conditions on the feeder line 106) with values of corresponding load shedding parameters supplied to the device 104. In one embodiment, the utility 101 initially sets the values of the load shedding parameters for the load shedding device 104 while in other embodiments, the values of the load shedding parameters may be preset. The utility 101 can update the load shedding parameters over time if required. In some embodiments, the utility 101 and/or another device (e.g., one or more components of the DER 108) may communicate with the load shedding device 104 using power line communication (PLC) for initially setting and/or updating the values of the load shedding parameters.

The load shedding device 104 comprises a load shedding controller 120 that monitors the feeder line 106 and detects whether the conditions outlined in the load shedding parameters are met; i.e., the load shedding device 104 compares the values of one or more monitored grid parameters with one or more load shedding parameters to determine whether the conditions to perform load shedding have been met. For example, the frequency of the local grid waveform on the feeder line 106 (which may be referred to as the frequency of the grid or the grid frequency) may fall below a particular threshold frequency when load has increased to a degree where load shedding is required. Thus, the frequency of the grid provides indicia of an overload condition; i.e., as a power grid becomes overloaded, the grid frequency becomes lower.

In one or more embodiments, when the load shedding controller 120 detects that the grid frequency on the feeder line 106 has dropped below a load shedding frequency threshold for a particular length of time, the load shedding controller 120 directs the load shedding device 104 to disconnect the loads 114 (i.e., one or more loads at the residence/site) via a signal to control, for example, a switch or relay as depicted and described with respect to FIG. 2. In certain embodiments, rather than disconnecting all of the loads 114 from the feeder line 106, only non-critical loads are disconnected during load shedding.

When conditions for load shedding are not met (e.g., the grid frequency on the feeder line 106 remains within a desired frequency range, or the grid frequency drops below the load shedding threshold for a period of time less than a predetermined minimum period of time), the load shedding device 104 continues regular operation by allowing the loads 114 to consume grid power. Accordingly, energy loss associated with non-granular load shedding is significantly mitigated because each individual home 102 is capable of performing load shedding while keeping the corresponding energy-generating resources (e.g., the DER 108) connected to the feeder line 106.

The capability to shed loads while keeping DERs online dramatically increases the effectiveness of load shedding schemes on utility circuits with high levels of connected DERs. The load shedding device 104 may be employed for retrofit applications on facilities with existing DERs and for new installations of DERs. The load shedding device 104 operates autonomously once initial load shedding parameters are set, though these parameters may be updated. For example, parameters in the load shedding controller 120 can be updated by the utility 101 over a communications network 150 using one or more wireless and/or wired communication techniques; additionally or alternatively, the utility 101 communicates with the load shedding device 104 using PLC to update the load shedding parameters.

FIG. 2 depicts a block diagram of a load shedding device 104 in accordance with exemplary embodiments of the present invention.

The load shedding device 104 comprises the load shedding controller 120, a load shedding circuit 201, a meter socket interface 210, and a meter interface 212. The meter interface 212 electrically couples the load shedding device 104 to the meter 110, and the meter socket interface electrically couples the load shedding device 104 to the meter socket 122.

The load shedding circuit 201 comprises a relay 202 having an armature 260 and a coil 262. One terminal of the armature 260 is coupled to the meter interface 212 while the other terminal of the armature 260 is coupled to the meter socket interface 210. The coil 202 is coupled to the load shedding controller 120 for receiving a control signal to drive the armature 260 such that the meter interface 212 is electrically connected to/disconnected from the meter socket interface 210 by closing/opening the armature 260, respectively. The relay 202 may be a normally open relay, a normally closed relay, or any suitable relay or connection/disconnection device to electrically connect/disconnect the meter interface 212 and the meter socket interface 210 on command.

The load shedding circuit 201 further comprises an overcurrent device 211 that electrically couples the DER 108 to the meter interface 212 such that when the armature 260 is open, the DER 108 remains connected to the meter interface 212 (and hence to the meter 110 and the feeder line 106) while the meter socket interface 210 (and hence the meter socket 122, the load center 112, and the loads 114) is disconnected from the meter interface 212.

In a conventional configuration, i.e., when the load shedding device 104 is not present, the meter 110 would be directly coupled to the meter socket 122 to provide power to the residential loads 114 from the grid. However, according to exemplary embodiments of the present invention, the meter 110 is coupled to the load shedding device 104 via the meter interface 212. The load shedding device 104 is then coupled to the meter socket 122 via the meter socket interface 210. In this configuration, the load shedding device 104 acts as an interface between the feeder line 106 (i.e., the grid) and the residential loads 114 and can disconnect the loads 114 while maintaining power generation to support the grid by the DER 108.

The load shedding device 104 receives initial settings for the load shedding parameters (e.g., from the utility 101, from the DER 108, or from another component or system) or, alternatively, the initial settings are preset at the factory. In some embodiments, these initial settings include a disconnect frequency threshold, a reconnect frequency threshold, a time delay for disconnecting (which may also be referred to as a disconnection time delay), and a time delay for reconnecting (which may also be referred to as a reconnection time delay) and hysteresis, i.e., having a first threshold level for disconnecting the loads 114 that differs from a second threshold level for reconnecting the loads 114. Those of ordinary skill in the art will recognize that other parameters can be set on the load shedding device 104 as dictated by the context of the load shedding device 104. Those of ordinary skill in the art will recognize that the thresholds or time delays can be determined through historical analysis on past behavior and the thresholds can be dynamic. In some embodiments, the load shedding device 104 may determine one or more settings for one or more of the load shedding parameters; for example, a disconnect frequency threshold may be determined based on historical analysis of the monitored grid frequency.

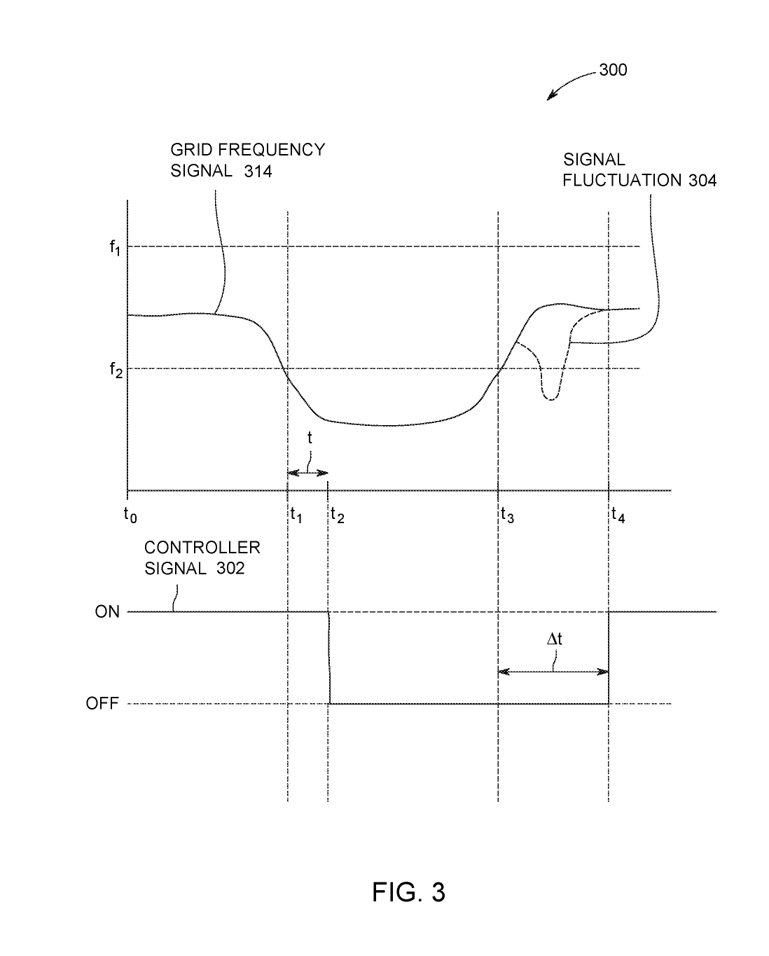

The load shedding controller 120 operates the load shedding circuit 201 to disconnect/connect the loads 114 from/to the feeder line 106—while maintaining the connection between the DER 108 and the feeder line 106—according to a controller signal such as controller signal 302 shown in FIG. 3 and described further below.

The load shedding controller 120 includes one or more processors 202 coupled to each of various support circuits 206, an input/output (I/O) interface 208, and a memory 204. The processors 202 may include one or more microprocessors known in the art. The support circuits 206 for the processor 202 include conventional cache, power supplies, clock circuits, data registers, I/O interface 208, and the like. The I/O interface 208 may be directly coupled to the memory 204 or coupled through the support circuits 206. The I/O interface 208 may also be configured for communication with input devices and/or output devices such as network devices, various storage devices, mouse, keyboard, display, video and audio sensors and the like.

The memory 204, or computer readable medium, stores non-transient processor-executable instructions and/or data that may be executed by and/or used by the processor 202. These processor-executable instructions may comprise firmware, software, and the like, or some combination thereof. Modules having processor-executable instructions that are stored in the memory 204 comprise a controller module 210. The controller module 210, when executed, monitors one or more grid parameters, such as grid frequency; compares the values of one or more monitored grid parameters to the values or one or more load shedding parameters to determine whether to disconnect from/connect to the feeder line 106 and to generate a corresponding signal (e.g., the controller signal 302 described below with respect to FIG. 3) to drive the relay 202 accordingly. Additionally, the memory 204 stores a database 240 for storing data, such as data related to the present invention (e.g., settings for the load shedding parameters).

The load shedding controller 120 may be programmed with one or more operating systems 250 (stored in the memory 204), which may include OS/2, Linux, SOLARIS, UNIX, HPUX, AIX, WINDOWS, IOS, and ANDROID among other known platforms. In some embodiments, the load shedding controller 120 may be an ASIC with an embedded operating system. The memory 204 may include one or more of the following: random access memory, read only memory, magneto-resistive read/write memory, optical read/write memory, cache memory, magnetic read/write memory, and the like, as well as signal-bearing media as described below.

Those skilled in the art will appreciate that load shedding controller 120 is merely illustrative and is not intended to limit the scope of embodiments. In particular, the load shedding controller 120 may include any combination of hardware or software that can perform the indicated functions of various embodiments, including computers, network devices, Internet appliances, personal digital assistants (PDAs), wireless phones, pagers, and the like. The load shedding controller 120 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from load shedding controller 120 may be transmitted to load shedding controller 120 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

FIG. 3 illustrates a timing diagram 300 for controlling a load shedding controller 120 according to grid frequency in accordance with exemplary embodiments of the present invention.

The load shedding controller 120 monitors a grid frequency signal 314, determined by the controller module 210, as illustrated in FIG. 3. The grid frequency signal 314 remains between an upper grid frequency threshold f₁ and a load shedding frequency threshold f₂ for a time period from t₀ to t₁. Accordingly, while the grid frequency signal 314 remains above the load shedding frequency threshold f₂, the controller signal 302 remains in an “on” state, maintaining the relay 202 in the “set” position (i.e., the armature 260 is closed) such that the grid (i.e., the feeder line 106) and the loads 114 remain connected and the grid can still support the loads 114. In some embodiments, the “on” state corresponds to the controller signal 302 being at a logical high level, e.g., as depicted in FIG. 3.

At time t₁, the grid is experiencing difficulties in maintaining its load such that the grid frequency signal 314 falls below the load shedding frequency threshold f₂. If the grid frequency signal 314 remains below the load shedding frequency threshold f₂ for a predetermined length of time “t”, as shown in FIG. 3 from t₁ to t₂, the controller signal 302 of the load shedding controller 120 switches to an “off” state (e.g., a logical low level), resetting the relay 202 (i.e., opening the armature 260) and thereby breaking the connection between the meter 110/meter socket 122 and causing the loads 114 to be shed from the grid. However, the load shedding circuit 201 maintains the connection from the DER 108 to the grid, allowing the generated power from DER 108 to be supplied to the grid despite local load shedding conditions. In some other embodiments, the controller signal 302 switches to an “off” state as soon as the grid frequency falls below the load shedding frequency threshold f₂.

The load shedding delay time “t”, which also may be referred to as the time delay for disconnecting or the disconnection time delay, may be supplied as part of the initial settings. The load shedding device 104 also receives a “Δt” reconnection time delay parameter as a part of the initial settings. The “Δt” reconnection time delay parameter, depicted between times t₃ and t₄ in FIG. 3, allows the local grid conditions a small time delay in correcting the grid frequency before the relay 202 is set to account for any grid frequency fluctuations (shown in phantom as signal fluctuation 304) that may occur before the grid stabilizes and the grid frequency remains above the threshold f2.

In some embodiments, the load shedding controller 120 adds an additional randomly generated time delay (t_delay) between zero and “t” seconds to the reconnection time delay to ensure that load is added gradually back to the grid following an under-frequency event. For example, after the grid frequency signal 314 rises above the threshold f₂ again, the grid frequency signal 314 might experience a small signal fluctuation 304 where the grid frequency dips below the threshold f2 before the grid conditions stabilize. The controller signal 302 remains off until the total reconnection time delay time “t_delay” and “Δt” have elapsed accounting for this fluctuation. After this period elapses, the relay 202 is set by the controller signal 302, causing the grid to supply power to the residential loads 114. In certain embodiments, At may be equal to zero and the total reconnection time delay is equal to the randomly generated time delay “t_delay”. In other embodiments, the total reconnection time delay is equal to Δt.

In some embodiments, the load shedding device 104 also receives parameters related to hysteresis where different frequency thresholds are established for setting and resetting the relay 202 in load shedding circuit 201. For example, in some such embodiments, the upper grid frequency threshold f₁ depicted in FIG. 3 is a load reconnect frequency threshold where the relay 202 is set by the controller signal 302 to reconnect the grid to the loads 114 after the grid frequency signal 314 rises above the threshold f₂ and remains above the threshold f₂ for some period of time.

In some embodiments, one or both of the set and reset threshold frequencies (i.e., the connect and disconnect frequency thresholds) are dynamically established by an algorithm using historical frequency levels and switching thresholds in order to optimize the on/off periods for the controller signal 302.

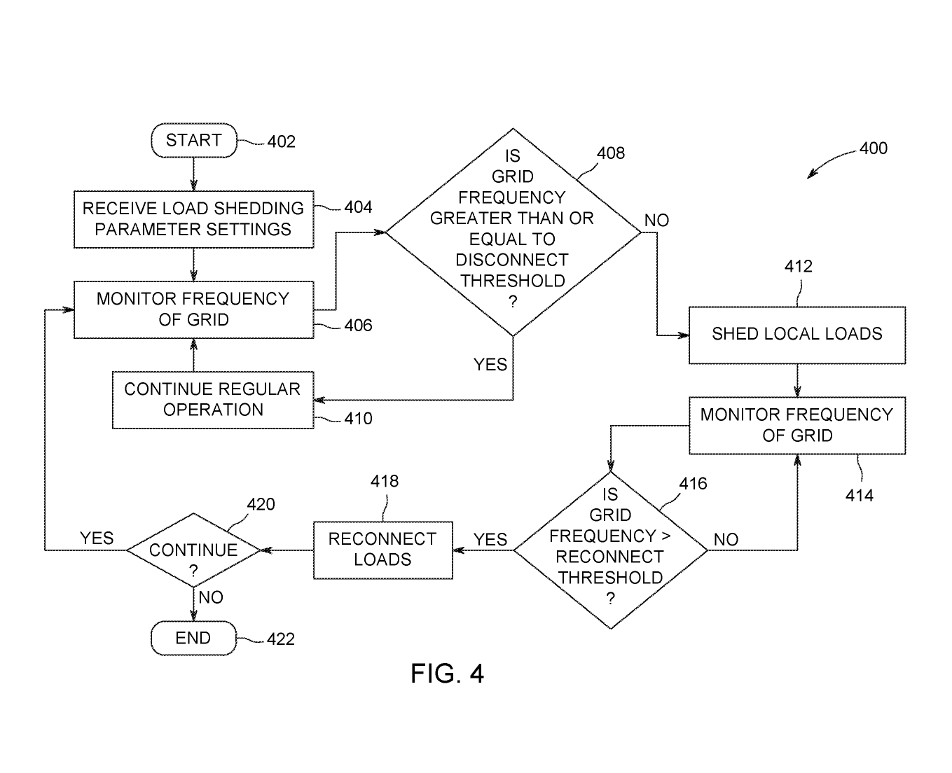

FIG. 4 is a flow diagram of a method 400 for load shedding while maintaining DER support for a power grid distribution system in accordance with exemplary embodiments of the present invention. A load shedding device couples a DER to the power grid distribution system, or grid, by a first connection and further couples at least one load to the grid by a second connection that can be dynamically controlled to disconnect the at least one load when the grid frequency falls below a disconnect threshold and to reconnect the at least one load when the grid frequency rises above a reconnect threshold. In one or more embodiments of the method 400, such as the embodiment described below, the load shedding device is the load shedding device 104 of the power distribution system 100 previously described, and the method 400 is implemented by the controller module 210 as an exemplary implementation of the load shedding controller 120 executed by the processors 202.

The method 400 begins at step 402 and proceeds to step 404. At step 404, the controller module 210 receives settings for load shedding parameters, for example from a utility provider. These parameters comprise at least one of a grid frequency range (i.e., a load shedding frequency threshold which also may be referred to as a load disconnect frequency threshold, and a load reconnect frequency threshold), one or more delay time periods (e.g., a load shedding delay time, a load reconnect delay time), hysteresis settings and the like. In certain embodiments the load disconnect and load reconnect frequency thresholds may be equal, while in other embodiments the load reconnect frequency threshold is greater than the load disconnect frequency threshold. Additional load shedding parameters can be added or removed as necessary.

The controller module 210 is enabled to receive updates to the load shedding parameters, and/or their settings, over a network, such as a communications network (e.g., via the Internet) or through other means of communication from the utility 101 (e.g., PLC). The load shedding parameters and/or their settings may also be pre-set at the factory or, for example, at the utility prior to delivery to the location for use. In some other embodiments, the settings for the load shedding parameters may be communicated from the DER (e.g., using PLC) or from another component or system.

At step 406, the controller module 210 monitors the frequency of the grid (i.e., the frequency of the voltage waveform on the feeder line 106). The frequency of the grid provides indicia of an overload condition, i.e., as a power grid becomes overloaded, the grid frequency becomes lower.

At step 408, a determination is made whether the grid frequency remains above a disconnect frequency threshold (e.g., the controller module 210 compares the grid frequency with the disconnect frequency threshold). If the grid frequency is greater than or equal to the disconnect threshold frequency, the controller module 210 does nothing and the load shedding device continues regular operation at step 410; i.e., the loads 114 remain connected to the feeder line 106. The method 400 then returns to step 406.

If, at step 408, it is determined that the grid frequency is below the disconnect frequency threshold, the method 400 proceeds to step 412 where the loads 114 are disconnected from the feeder line 106 while the connection between the DER 108 and the feeder line 106 is maintained (e.g., the controller module 210 directs the loads 114 to be shed by the load shedding device 104 by resetting the relay 202 to open the armature 260). In some embodiments, control signal to shed the loads 114 will be generated immediately when the disconnect frequency threshold is crossed. In other embodiments, the controller module 210 waits until the grid frequency has remained below the disconnect frequency threshold for a period of time before generating the control signal to disconnect the loads 114.

The method 400 proceeds to step 414. At step 414, the controller module 210 continues monitoring the grid frequency. At step 416, a determination is made whether the grid frequency has risen to exceed a reconnect frequency threshold (e.g., the controller module 210 compares the grid frequency with the reconnect frequency threshold). In some embodiments, the disconnect frequency threshold and the reconnect frequency threshold are equal to one another. In other embodiments, the reconnect frequency threshold is greater than the disconnect frequency threshold to account for any grid frequency fluctuations that may occur before the grid stabilizes and the grid frequency remains above the reconnect frequency threshold. If the result of the determination is no, that the grid frequency is below the reconnect frequency threshold, the method 400 returns to step 414. If the result of the determination is yes, that the grid frequency exceeds the reconnect frequency threshold, the method 400 proceeds to step 418.

At step 418, the loads 114 are reconnected to the feeder line 106 (e.g., the controller module 210 directs the load shedding device 104 to reconnect the loads 114 to the feeder line 106 by setting the relay 202). In some embodiments, the controller module 210 issues the reconnect command immediately when the reconnect frequency threshold is crossed. In other embodiments, the controller module 210 waits until the grid frequency has remained above the reconnect frequency threshold for a period of time before issuing the reconnect command.

The method 400 proceeds to step 420 where a determination is made whether to continue operation. If the result of the determination is yes, the method 400 returns to step 406. If the result of the determination is no, the method 400 proceeds to step 422 where it ends.

The foregoing description of embodiments of the invention comprises a number of elements, devices, circuits and/or assemblies that perform various functions as described. These elements, devices, circuits, and/or assemblies are exemplary implementations of means for performing their respectively described functions.

While the foregoing is directed to embodiments of the present invention, other and further embodiments of the invention may be devised without departing from the basic scope thereof, and the scope thereof is determined by the claims that follow.

1. A method for load shedding while maintaining distributed energy resource (DER) support of a power grid, the method comprising:
monitoring, by a load shedding device that electrically couples a power grid to each of a distributed energy resource (DER) and at least one load, a frequency of the power grid;
determining whether the frequency is less than a load disconnect frequency threshold; and
disconnecting, by the load shedding device when the frequency is less than the load disconnect frequency threshold, the at least one load from the power grid while maintaining the electrical connection between the DER and the power grid.

2. The method of claim 1, wherein the at least one load is disconnected after the frequency remains below the load disconnect frequency threshold for a period of time.

3. The method of claim 1, wherein the load disconnect frequency threshold is communicated to the load shedding device by a power utility.

4. The method of claim 1, further comprising:
determining, subsequent to disconnecting the at least one load, whether the frequency is greater than a load reconnect frequency threshold; and
reconnecting, by the load shedding device, the at least one load to the power grid when the frequency is greater than the load reconnect frequency threshold.

5. The method of claim 4, wherein the at least one load is reconnected after the frequency remains above the load reconnect frequency threshold for a second period of time.

6. The method of claim 4, wherein the load reconnect frequency threshold is greater than the load disconnect frequency threshold.

7. The method of claim 1, wherein the DER is a solar power system.

8. A load shedding device for load shedding while maintaining distributed energy resource (DER) support of a power grid, the load shedding device comprising:
a load shedding circuit for electrically coupling a power grid to each of a distributed energy resource (DER) and at least one load; and
a controller module, coupled to the load shedding circuit, for (i) monitoring a frequency of the power grid, (ii) determining whether the frequency is less than a load disconnect frequency threshold, and (iii) disconnecting, when the frequency is less than the load disconnect frequency threshold, the at least one load from the power grid while maintaining the electrical connection between the DER and the power grid.

9. The load shedding device of claim 8, wherein the at least one load is disconnected after the frequency remains below the load disconnect frequency threshold for a period of time.

10. The load shedding device of claim 8, wherein the load disconnect frequency threshold is communicated by a power utility.

11. The load shedding device of claim 8, wherein the controller module further (iv) determines, subsequent to disconnecting the at least one load, whether the frequency is greater than a load reconnect frequency threshold, and (v) reconnects the at least one load to the power grid when the frequency is greater than the load reconnect frequency threshold.

12. The load shedding device of claim 11, wherein the at least one load is reconnected after the frequency remains above the load reconnect frequency threshold for a second period of time.

13. The load shedding device of claim 11, wherein the load reconnect frequency threshold is greater than the load disconnect frequency threshold.

14. The load shedding device of claim 8, wherein the DER is a solar power system.

15. A system for load shedding while maintaining distributed energy resource (DER) support of a power grid, the system comprising:
a DER; and
a load shedding device comprising:
a load shedding circuit for electrically coupling a power grid to each of the DER and at least one load; and
a controller module, coupled to the load shedding circuit, for (i) monitoring a frequency of the power grid, (ii) determining whether the frequency is less than a load disconnect frequency threshold, and (iii) disconnecting, when the frequency is less than the load disconnect frequency threshold, the at least one load from the power grid while maintaining the electrical connection between the DER and the power grid.

16. The system of claim 15, wherein the at least one load is disconnected after the frequency remains below the load disconnect frequency threshold for a period of time.

17. The system of claim 15, wherein the load disconnect frequency threshold is communicated by a power utility.

18. The system of claim 15, wherein the controller module further (iv) determines, subsequent to disconnecting the at least one load, whether the frequency is greater than a load reconnect frequency threshold, and (v) reconnects the at least one load to the power grid when the frequency is greater than the load reconnect frequency threshold.

19. The system of claim 18, wherein the at least one load is reconnected after the frequency remains above the load reconnect frequency threshold for a second period of time.

20. The system of claim 18, wherein the load reconnect frequency threshold is greater than the load disconnect frequency threshold.
